(19) United States
(12) Patent Application Publication
(10) Pub. No.: US 2010/0135542 A1
(43) Pub. Date: Jun. 3, 2010

(54) System and methods for biometric identification on smart devices using multos

(76) Inventors: Lester H. Keepper, JR., OakBrook, IL (US); Marc Jacquinot, Marietta, GA (US); Mark McGovern, Leesburg, VA (US); Ray Pedden, Redwood City, CA (US); Daryl Strickland, Charlotte, NC (US); Dovell M. Bonnett, Ladera Ranch, CA (US)

Correspondence Address: Valauskas & Pine LLC, 150 South Wacker Drive, Suite 620, Chicago, IL, 60606, US

(21) Appl. No.: 12/586,278

(22) Filed: Sep. 18, 2009

Related U.S. Application Data
(60) Provisional application No. 61/098,195, filed on Sep. 18, 2008.

(51) Int. Cl. G06K 9/00

(52) U.S. Cl. 382/124

(57) ABSTRACT

Biometric enrollment and identification, including authorization and access, capability for integrated circuit chips (“ICCs”) using the multi-application operating system (“MULTOS”). The ICC of a smart device reviews biometric data to authenticate identity in order to grant or deny a user instant or real-time access to secured information. A match-on-chip (“MOC”) algorithm of the ICC performs a one-to-one correspondence for comparing a stored reference template of an individual biometric element and a live sample template.

### PRIORITY STATEMENT

This application claims priority to U.S. Provisional Ser. No. 61/098,195, filed Sep. 18, 2008.

### FIELD OF THE INVENTION

The present invention relates generally to smart devices that include embedded integrated circuit chips (“ICCs”). More specifically, the present invention relates to a smart device operating on a multi-application operating system (“MULTOS”) to review biometric data to authenticate identity in order to grant or deny a user instant or real-time access to secured information, wherein review of the biometric data takes place entirely on the smart device.

### BACKGROUND OF THE INVENTION

Smart cards include embedded integrated circuit chips (“ICCs”) which can process data. The embedded integrated circuits typically include a processor, microprocessor or central processing unit (“CPU”), random access memory (“RAM”) or programmable read-only memory (“PROM”), read-only-memory (“ROM”), electrically erasable programmable read-only-memory (“EEPROM”), and Input/Output (“I/O”).

The processors in smart cards can be programmed like any other computer to perform desired functions. Smart card readers read the contents of a smart card as well as interact with the smart card to change its contents and to accomplish cooperative functions which can range from the simple to the sophisticated.

MULTOS is a multi-application operating system that enables a smart card to carry a variety of applications, for example, contactless payment, internet authentication and loyalty, national identity with digital signature, ePassport with biometrics, healthcare and military base, and network access control.

MULTOS provides an operating system upon which resides a virtual machine. A virtual machine (“VM”) is a software implementation of a machine, for example a computer, that executes programs like a real machine.

A key difference of MULTOS from other types of operating systems is that it implements Secure Trusted Environment Provisioning (“STEP”). STEP allows the manufacture, issuance, and dynamic updates of smart cards to be entirely under the issuer's control. This control is enforced through the use of a Key Management Authority (“KMA”). The KMA provides issuers with public key cryptographic functionality required to bind the smart card to the issuer, initialize the smart card for use, and generate permission certificates for the loading and deleting of applications under the control of the issuer.

Generally, biometrics refers to the science of using automated methods for recognizing biological, physiological, or behavioral characteristics that are absolutely unique to individuals. Recognizing characteristics unique to individuals typically involves methods to capture, store, and examine the characteristics for identification of an individual by automated means.

Using biometrics to identify an individual is becoming a requirement in various industries, for example, healthcare, banking, business, government, and various other industries. Biometric identification prevents intruders, pretenders, and hackers from gaining access to secured information.

Current implementations of biometrics with MULTOS enabled smart cards for identification of a user do not include a real-time or instant comparison of certain data that occurs entirely on the smart card thereby reducing risk associated with all or a portion of the data residing on external sources. Reducing risk includes reducing the susceptibility of theft, modification, replacement, play-back, or other attacks that threatens secured information.

The present invention addresses the need for smart devices that work with the multi-application smart card operating system (“MULTOS”) for identification and further provides for real-time data processing entirely on the smart device.

### SUMMARY OF THE INVENTION

Smart devices using MULTOS and MULTOS applications are intended for high security environments due to the design capabilities of uniquely holding data such as information and applications in separate, discreet internal protected silos, which are limited only by the available memory on the ICC of the smart device.

For the purpose of this invention, a biometric system encapsulated within the ICC analyzes the biometric sample using a match-on-chip (“MOC”) algorithm to identify and record distinctive and unique biometric elements such as patterns. The resulting biometric elements are then digitized to create a single binary code-based reference template or sample template. The MOC algorithm then compares the reference template or sample template inside the ICC of the smart device. Thus, all computations are performed by the ICC.

The MOC algorithm compares the stored reference template of an individual's biometric element and the live sample template, specifically the reference points of the reference template and the sample template. This is considered a one-to-one correspondence providing a fast, reliable, and accurate comparison.

This invention creates an improved technology for secure enrollment and identification including authentication and authorization using functionality that eliminates the exposure of sensitive biometric information or data from being vulnerable to attack. After a successful authentication, the MOC algorithm signals the ICC of the smart device to allow access to secure information including for example execution of programs, applications, and algorithms. If the authentication is unsuccessful, the MOC algorithm has the ability in accordance to the policy of the issuer to deny or prohibit access the ICC of the smart device.

According to the present invention, a smart device reviews biometric data to authenticate identity in order to grant or deny a user instant or real-time access to secured information. For purposes of this application, the term biometric data refers to one or more biometric samples, reference templates, and/or sample templates discussed more fully below. If a user is granted access or authorized, the user may instantly access secured information.

Secured or secure information is anything that requires restricted access such as a physical location, programs, applications, algorithms, data or information such as personal records, for example, health records, medical records, vital records, protected application on the computer requiring vetted identity, to name a few. According to the present invention, the secured information may reside on the smart device, computer, network of computers, to name a few. The secured information may be accessed on the smart device, computer, or network of computers through a communication link such as the Internet, Intranet, or Extranet.

There are two procedures that ensure the integrity of the systems and methods according to the present invention: enrollment and identification.

First, a user enrolls with an issuer for biometric identification on smart devices using MULTOS. For purposes of this application, a smart device is anything that may include an integrated circuit chip (“ICC”), for example, cards, memory sticks, pens, subscriber identity modules (“SIMs”), universal serial bus (“USB”) tokens or drives, electronic devices such as personal data assistants (“PDAs”), to name a few.

For purposes of the application, an issuer is any person or individual, entity, government, organization, or group offering products or services according to the present invention. A user is any person or individual, entity, corporate or government, organization or group desiring the products or services of the issuer.

To begin the enrollment procedure, cross-communication is established between a smart device and a sensor device. For purposes of this application, a sensor device is anything that interacts with smart devices and specifically reads a data such as a biometric sample from the ICC of the smart device. Examples of sensor devices include, for example, a biometric reader, a computer, virtual computer, automated teller machine (“ATM”), a point of sale terminal, or a mobile telephone. Sensor devices further include an input element such as a scanner or reader.

The cross-communication between the smart device and the smart reader is established when there is engagement between the smart device and the sensor device. Engagement may be referred to as contact or contactless. A contact engagement is where the sensor device physically accepts the smart device such as via a slot or receptacle. A contactless engagement is where the sensor device accepts the smart device through remote-frequency identification (“RFID”). Once a smart device is engaged with a sensor device—either through contact or contactless engagement—the sensor device performs an analysis of the smart device to determine authenticity, functionality, capabilities, and resource requirements to establish the cross-communication.

After cross-communication is established by the sensor device and the smart device, a biometric enrollment application requests that the user present a biometric sample to the sensor device, more specifically the input element, a required number of times (“x” times).

In certain embodiments, a sensor device is further connected to a computer. The computer may provide a user interface such as a display device to visually, for example through graphics, communicate with a user. It is also contemplated that the computer may aurally communicate with the user. The enrollment application may instruct the computer connected to the sensor device to display a graphic on the display device instructing the user to submit the desired biometric sample to the sensor device, for example, a graphic of a hand with the desired finger highlighted on the display device such as with an “X”, different color, etc.

The user presents a biometric sample to the sensor device. Biometric samples include anything that provides unique patterns associated with a user of the present invention. These include fingerprints, facial recognition, vein patterns, hand geometry, iris recognition, dynamic signature analysis, keystroke analysis, retinal scan, speaker verification, to name a few.

The biometric application captures, examines, and verifies the biometric sample including a check for clarity including similarity and completeness. If the biometric sample does not meet standards, a request is made to resubmit another biometric sample. In one embodiment, it is determined if the biometric sample is equal to or greater than a pre-determined clarity threshold.

When the biometric sample is less than the clarity threshold, the user represents an additional biometric sample to the sensor device. Once the biometric sample meets standards such as being equal to or greater than a clarity threshold, the smart device converts such as by digitizing the biometric sample to a reference template. A match-on-chip (“MOC”) algorithm is executed on the smart device such that the reference template is stored on the smart device. More particularly, the reference template is stored in the ROM of the ICC of the smart device.

If there are additional biometric templates to be stored on the smart device, the user is requested to present further biometric samples.

In certain embodiments, the number of times the user presents, re-presents, or attempts to provide a biometric sample is calculated. The MOC algorithm may verify compliance of the number of attempts, including incomplete scans or mis-matches of the biometric sample, with a policy limit. If the number of attempts reaches or exceeds the policy limit, the enrollment procedure terminates.

According to the present invention, the issuer formulates and implements the policy. The policy may include instructions, regulations, requirements, or modifications for activities associated with offering or performing products or services including enrollment and identification procedures.

Once enrollment is complete, the smart device is capable of participating in the identification procedure:

The identification procedure includes establishing cross-communication between the smart device and a sensor device. The cross-communication between the smart device and the smart reader is established when there is engagement between the smart device and the sensor device. The smart device includes the reference template as established in the enrollment process. Once a smart device is engaged with a sensor device—either through contact or contactless engagement—the sensor device performs an analysis of the smart device to determine authenticity, functionality, capabilities, and resource requirements to establish the cross-communication.

After cross-communication is established by the sensor device and the smart device, an access control application requests that the user present a biometric sample to the sensor device, more specifically the input element. It is further contemplated that the sensor device allows a user to present a biometric sample a limited number of times (“y” times), after which, if none of the presented biometric samples are successful, further attempts are rejected.

Again, in certain embodiments, the sensor device is further connected to a computer. The computer may visually or aurally communicate with the user. The access control application may instruct the computer connected to the sensor device to display a graphic on the display device instructing the user to submit the desired biometric sample to the sensor device.

The biometric application captures, examines, and verifies the biometric sample including a check for clarity including similarity and completeness. If the biometric sample does not meet standards, a request is made to resubmit another biometric sample. In one embodiment, it is determined if the biometric sample is equal to or greater than a pre-determined accuracy threshold.

When the biometric sample is less than the accuracy threshold, the user is requested to re-present an additional biometric sample to the sensor device. Once the biometric sample meets standards such as being equal to or greater than the accuracy threshold, the smart device converts such as by digitizing the biometric sample to a sample template. The match-on-chip (“MOC”) algorithm is executed on the smart device to compare the reference template and the sample template, specifically reference points of the reference template and reference points of the sample template. The MOC algorithm determines if there is a match between the reference template and the sample template. If the reference template and the sample template match, the user is permitted to access to secure information.

If the reference template and the sample template do not match, a request is made to resubmit another biometric sample. The number of times the user presents, re-presents or attempts to provide a biometric sample is calculated. The MOC algorithm may verify compliance of the number of attempts with a policy limit. If the number of attempts reaches or exceeds the policy limit, the identification procedure is disabled. Disabling may include rejecting, locking, or permanently disabling the communication between the smart device and sensor device.

### DESCRIPTION OF THE DRAWINGS

FIG. 1 is a flow chart of a user enrolling with an issuer for biometric identification on smart devices using MULTOS according to the present invention; and

FIG. 2 is a flow chart of a user activating one embodiment of a biometric identification process on smart devices using MULTOS according to the present invention.

### DETAILED DESCRIPTION OF THE INVENTION

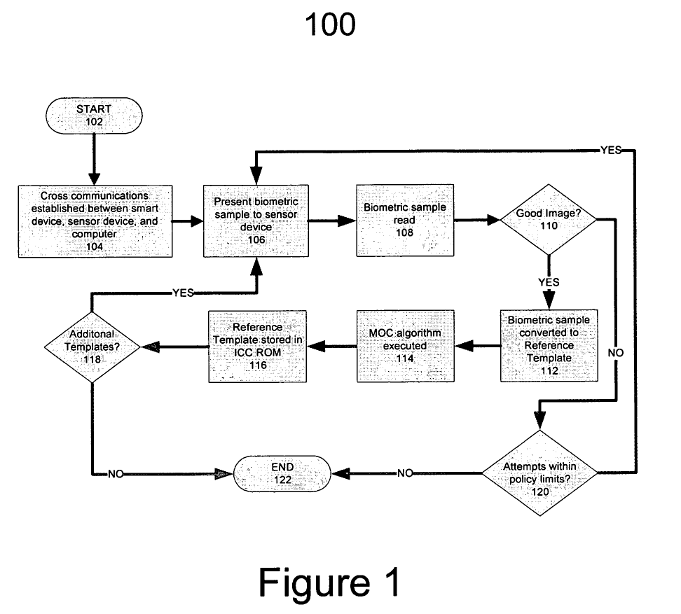

FIG. 1 is a flow chart 100 of a user enrolling with an issuer for biometric identification on smart cards using MULTOS according to the present invention. For purposes of this embodiment, the smart device is a smart card, the biometric reader is a biometric reader that includes a scanner input element, and the biometric sample is a fingerprint.

Cross-communication is established between the smart card and biometric reader at step 104. In this embodiment, the biometric device physically accepts the smart card through a slot or receptacle. Once a smart card is engaged with a biometric reader, the biometric reader performs an analysis of the smart card to determine authenticity, functionality, capabilities, and resource requirements to establish the cross-communication.

In the embodiment described, the biometric reader is further connected to a computer. The computer provides a user interface in the form of a display device to visually communicate with the user by requesting that the user present a biometric sample to the scanner of the biometric reader at step 106. At step 108, the biometric application captures, examines, and verifies the fingerprint including a check against a pre-determined clarity threshold for clarity including similarity and completeness. If the fingerprint is not equal to or greater than the clarity threshold at step 110, a request is made to resubmit another fingerprint at step 106. The number of times the user presents, re-presents, or attempts to provide a fingerprint is calculated at step 120 to verify compliance with a policy limit. If the number of attempts reaches or exceeds the policy limit at step 120, enrollment ends at step 122.

If the fingerprint meets the clarity threshold at step 110, such as being equal to or greater than a clarity threshold, the smart card converts the fingerprint such as by digitizing the fingerprint to a reference template at step 112. At step 114, the match-on-chip (“MOC”) algorithm is executed on the smart card such that the reference template is stored in the ROM of the ICC of the smart card at step 116.

If there are additional biometric templates to be stored on the smart card at step 118, the user is requested to present further fingerprints or other biometric samples at step 106 and the procedure repeats. Otherwise, enrollment ends at step 122.

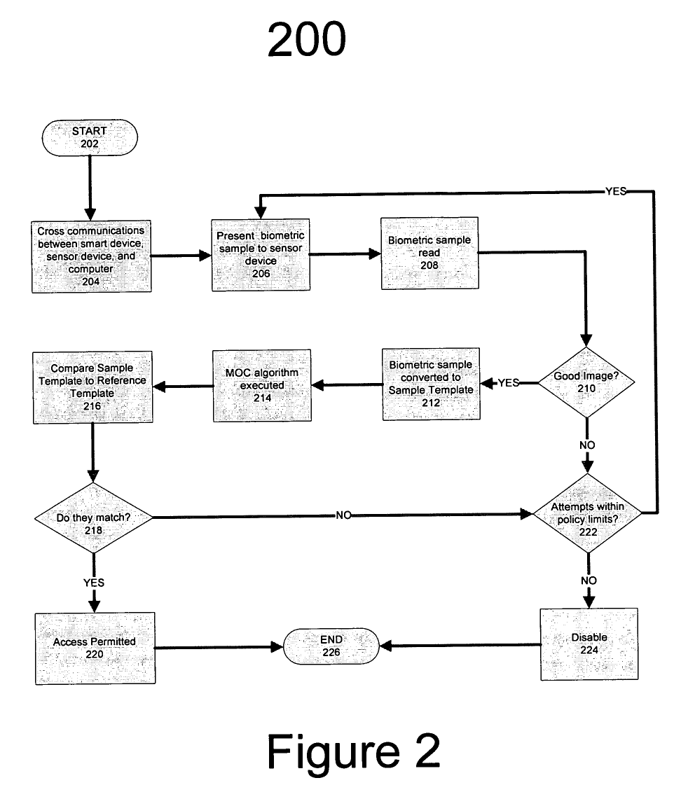

FIG. 2 is a flow chart 200 of a user activating one embodiment of a biometric identification process on a smart card using MULTOS according to the present invention.

Cross-communication is established between the smart card and biometric reader at step 204. In this embodiment, the biometric device physically accepts the smart card through a slot or receptacle. Once a smart card is engaged with a biometric reader, the biometric reader performs an analysis of the smart card to determine authenticity, functionality, capabilities, and resource requirements to establish the cross-communication.

In the embodiment described, the biometric reader is further connected to a computer. The computer provides a user interface in the form of a display device to visually communicate with the user by requesting that the user present a biometric sample to the scanner of the biometric reader at step 206. The smart card includes the reference template as established in the enrollment process as described in reference to FIG. 1.

In the embodiment described, the biometric reader is further connected to a computer. The computer provides a user interface in the form of a display device to visually communicate with the user by requesting that the user present a biometric sample to the scanner of the biometric reader at step 206. An access control algorithm instructs the computer connected to the biometric reader to present a graphic on the input device. In this embodiment, a graphic of a hand with the desired finger highlighted is displayed on the display device.

At step 208, the biometric application captures, examines, and verifies the fingerprint including a check against a pre-determined accuracy threshold for clarity including similarity and completeness. If the fingerprint is not equal to or greater than the accuracy threshold at step 210, a request is made to resubmit another fingerprint at step 206. The number of times the user presents, re-presents, or attempts to provide a fingerprint is calculated at step 222 to verify compliance with a policy limit. If the number of attempts reaches or exceeds the policy limit at step 222, the procedure is disabled at step 224 and ends at step 226.

When the fingerprint is less than the accuracy threshold at step 210, the user re-presents an additional fingerprint to the biometric reader at step 206. Once the fingerprint meets standards such as being equal to or greater than the accuracy threshold, the smart card converts, for example digitizing, the fingerprint to a sample template at step 212.

A match-on-chip (“MOC”) algorithm is executed at step 214 on the smart card and at step 216 the reference template and the sample template are compared. The MOC algorithm determines if there is a match between the reference template and the sample template at step 218. If the reference template and the sample template match at step 218, the user is permitted to access secure information at step 220 and the identification procedure ends at step 226.

If the reference template and the sample template do not match at step 218, the number of times the user presents, re-presents, or attempts to provide a fingerprint is calculated at step 222 to verify compliance of the number of attempts with a policy limit as described above. If the number of attempts reaches or exceeds the policy limit at step 222, the procedure is disabled at step 224 and ends at step 226. If the number of attempts does not reach or exceed the policy limit at step 222, a request is made to resubmit another fingerprint at step 206 and the procedure repeats.

While the disclosure is susceptible to various modifications and alternative forms, specific exemplary embodiments thereof have been shown by way of example in the drawings and have herein been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

What is claimed is:

1. A method for enrolling a user for biometric identification, comprising the steps of:
using a multi-application operating system (“MULTOS”);
establishing cross-communication between a smart device and a sensor device;
requesting a presentation of a biometric sample to the sensor device;
reading by the sensor device the biometric sample;
converting the biometric sample to a reference template;
executing match-on-chip algorithm on the smart device; and
storing the reference template on the smart device.

2. The method for enrolling a user for biometric identification of claim 1, wherein said reading step further comprises the steps of:
determining whether the biometric sample is equal to or greater than a pre-determined clarity threshold;
re-requesting the presentation of the biometric sample to the sensor device when the biometric sample is less than the clarity threshold.

3. The method for enrolling a user for biometric identification of claim 1 further comprising the steps of:
calculating the number attempts of said requesting step;
verifying compliance of the number of attempts with a policy limit; and
disabling the method if the number of attempts reaches or exceeds the policy limit.

4. The method for enrolling a user for biometric identification of claim 1, wherein the smart device is a smart card.

5. The method for enrolling a user for biometric identification of claim 1, wherein the sensor device is a biometric reader.

6. The method for enrolling a user for biometric identification of claim 1, wherein the biometric sample is a fingerprint.

7. A method for authenticating a user using biometric identification, comprising the steps of:
using a multi-application operating system (“MULTOS”);
establishing cross-communication between a sensor device and a smart device including a reference template;
requesting a presentation of a biometric sample to the sensor device;
reading by the sensor device the biometric sample;
converting the biometric sample to a sample template;
executing match-on-chip algorithm on the smart device;
comparing the reference template and the sample template;
determining a match between the reference template and the sample template; and
permitting or denying the user to access secure information based on said determining step.

8. The method for authenticating a user using biometric identification claim 7, wherein said reading step further comprises the steps of:
deciding whether the biometric sample is equal to or greater than an accuracy threshold;
re-requesting the presentation of the biometric sample to the sensor device when the biometric sample is less than the accuracy threshold.

9. The method for authenticating a user using biometric identification claim 7 further comprising the steps of:
calculating the number of attempts of said requesting step;
verifying compliance of the number of attempts with a policy limit; and
disabling the method if the number of attempts reaches or exceeds the policy limit.

10. The method for authenticating a user using biometric identification claim 7, wherein the smart device is a smart card.

11. The method for authenticating a user using biometric identification claim 7, wherein the sensor device is a biometric reader.

12. The method for authenticating a user using biometric identification claim 7, wherein the biometric sample is a fingerprint.
